(19) United States
(12) Patent Application Publication
(10) Pub. No.: US 2010/0100348 A1
(43) Pub. Date: Apr. 22, 2010

(54) Device for monitoring a product stream for interfering inclusion

(76) Inventor: Manfred Artinger, Schonberg (DE)

Correspondence Address: KENYON & KENYON LLP, ONE BROADWAY, NEW YORK, NY, 10004, US

(21) Appl. No.: 12/519,557

(22) PCT Filed: Dec. 12, 2007
(86) PCT No.: PCT/EP2007/010890

§ 371 Date: Dec. 11, 2009

(30) Foreign Application Priority Data
Dec. 22, 2006 (DE) 10 2006 061 041.5

(51) Int. Cl. G06F 19/00

(52) U.S. Cl. 702/81

(57) ABSTRACT

A device for monitoring a product stream for undesired inclusions wherein, in a section of the product stream which is to be monitored, a material-specific detection signal is derived by means of a sensor system comprising a plurality of sensors arranged in a staggered manner under formation of a sensor row in the direction of transport of the product stream and by means of an evaluation circuit associated with said sensor system, by simultaneously adding the output signals of the individual sensors in an addition circuit in a correlated manner, said output signals originating from single products with regard to metal particles in the product stream to be checked, and using the output signal of the addition circuit as a detection signal for a metal particle to be discovered. At least one sensor of a sensor row, the output signals of which are added in an antiphase manner to the output signals of other sensors for difference-taking purposes, is provided for the compensation of interfering magnetic fields. The resulting difference signals are evaluated in an addition circuit in a correlated manner, said addition circuit being provided for forming the detection signal.

### BACKGROUND INFORMATION

German Patent Application No. DE 100 11 230 A1 describes a solution for the discovery of interfering inclusions, such as small metal particles in a product stream, and also for their removal if necessary, said solution also allowing the discovery of very small metal inclusions even if these are contained in an envelope of a different metal. In devices of this type, a plurality of sensors is arranged in series in the direction of delivery and the output signals of said sensors are time-correlated such that signals of interfering metal particles are added algebraically and noise signals are added geometrically. Information about the correlation can be found in the book entitled “Korrelationselektronik” by Prof. Dr. Lange (e.g. on pages 22 et seq. and pages 338 et seq.) which is cited in German Patent Application No. DE 100 11 230 A1 and in German Patent Application No. DE 41 15 350 A1, and in other literature.

In devices of the type described in German Patent Application No. DE 100 11 230 A1, the objects to be checked usually are, therein, detected by means of an object sensor, such as an optical sensor, e.g. a photoelectric sensor, a mechanical object sensor or, alternatively, an acoustically operating sensor, which delivers the clock signal triggering for the electronic component. A further sensor detects the transport speed of the conveying device, e.g. a conveyor belt, and also supplies an appropriate signal to the electronic component, in order to facilitate a correlated evaluation in the sense mentioned. The individual sensors that are arranged consecutively in the direction of transport form a row of sensors. Delay lines and storages can be used for the delay of sensor signals. Particularly where a digital evaluation of the individual sensor signals is concerned, it is also possible to use the generally known digitally operating storages wherein sensor signals can be read into the individual storage areas thereof in digital form and subsequently read out in a correlated manner with regard to the object signal.

If use is made of Hall elements or magnetic dependent resistors (see Ahlers-Waldmann, “Mikroelektronische Sensoren”, pages 137-144/1st ed. VEB-Verlag Technik, Berlin 1989), metal detectors of this type have a very high response sensitivity and even allow the detection of very small ferromagnetic particles which are, for example, contained in an aluminum bag. If such metal detectors are used in industrial applications, however, the high response sensitivity can make itself felt in an interfering manner in that outside magnetic fields may produce interfering signals in the sensors. In practice, it is mostly attempted to solve this problem by magnetically shielding the complete system. However, this mostly has little effect, particularly if such interferences originate from parts present inside the shield.

Where a matrix of individual sensors serving to detect interfering inclusions was concerned, it was also attempted to counteract interfering magnetic fields by arranging a like second matrix underneath the former matrix spaced apart therefrom such that, although it absorbs the interfering magnetic fields, the latter does not respond to interfering inclusions in the stream of material being conveyed any longer. Each actual detection sensor is associated with a like sensor in the second matrix, and the corresponding sensors are connected differentially in order to obtain a signal that is cleared from outside magnetic fields. This method fails in case of interferences occurring in the proximity of the sensors and especially in case of a magnetic shield. In addition, the complexity in terms of circuitry is very high because the number of compensation sensors required is equal to the number of actual detection sensors. What is more, such a device is relatively susceptible because failures possibly occurring during operation increase with the number of components to a greater extent than just linearly.

### SUMMARY

According to an example embodiment of the present invention, the signal of at least one sensor of the sensor matrix in a device of the aforementioned type is added to signals of other sensors in an antiphase manner and each of the signals resulting from this addition is provided for correlation evaluation in order to generate a detection signal.

In a device of this type and according to a preferred embodiment of the present invention, the output signals of two consecutive sensors each in the direction of the product stream are added in an antiphase manner to compensate interfering outside magnetic fields and the signals resulting therefrom are added in a corresponding time-correlated manner to generate the detection signal.

The present invention can be applied both in a metal detector comprising only one row of sensors and in a metal detector comprising a sensor matrix. To prevent a blockage of the sensors, a magnetic shield containing an opening for the material being conveyed can additionally be provided against particularly strong outside magnetic fields.

The example embodiment of the present invention is based on the realization that the mentioned interferences caused by magnetic fields have a largely simultaneous and in-phase effect on all sensors, thereby causing practically all sensors to emit a signal corresponding to the interference in case of interfering fields. By means of an example embodiment according to the present invention, however, the output signals can be kept largely free from the influence of interfering fields.

### BRIEF DESCRIPTION OF THE DRAWINGS

Below, the present invention will be illustrated in more detail by means of the figures and exemplary embodiments presented therein.

FIG. 1 shows a device for discovering interfering inclusions in a material being conveyed which is, for example, packed in bags of aluminum foil and is conveyed on a conveyor belt, said device being provided with a metal detector.

FIG. 2 shows a matrix sensor array according to German Patent Application No. DE 100 11 230 described above, said matrix sensor array being applied in the device shown in FIG. 1.

FIG. 3 shows one of the sensor strips of the matrix sensor array shown in FIG. 2, said sensor strip allowing recognition of the arrangement of the individual sensors, and a schematic indication of the effect of inclusions to be detected in the material being conveyed and of an interference field on the sensors of the sensor strip.

FIG. 4 shows a three-dimensional diagram of the response sensitivity of a sensor designed as a Hall element or magnetic dependent resistor.

FIG. 5 shows the course of a signal of a bag containing an undesired inclusion with simultaneous exposure to an interfering outside field.

FIG. 6 shows a schematic diagram of the compensation process for discovering a material being conveyed which contains an undesired inclusion.

FIG. 7 shows an exemplary embodiment with compensation in case of an analog evaluation.

FIG. 8 shows an exemplary embodiment with compensation in case of a digitally operating evaluation.

FIG. 9 shows a further possibility of taking the difference between signals.

### DETAILED DESCRIPTION OF EXAMPLE EMBODIMENTS

The device shown in FIG. 1 consists of a basic frame 1 which can be aligned horizontally via vertically adjustable supporting feet 2 and of a conveying device for the material being conveyed, said conveying device being designed as conveyor belt 3 in the exemplary embodiment. A metal detector designed as a sensor matrix 4 is arranged underneath the conveyor belt 3 such that the individual sensors—see FIG. 3—face the conveyor belt 3 and, therefore, the material conveyed thereon. The sensor matrix 4 consists of concentrated single sensors in the form of Hall elements or magnetic dependent resistors (see the book entitled “Mikroelektronische Sensoren” by Ahlers-Waldmann, 1st ed. VEB-Verlag Technik Berlin, pages 137-144 and German Patent Application No. DE 100 11 230). The sensor matrix 4 feeds an evaluation circuit 5 which is combined with a control panel and an indicator panel in a manner that is known as such. The direction of transport of the conveyor belt 3 is indicated by a directional arrow. A device 6 is arranged in the end region of the conveyor belt 3, said apparatus 6 ejecting such material being conveyed that contains inclusions having been detected as interfering, such as chips of stainless steel (VA steel) or the like, into a collecting receiver 7. The ejection device 6 is designed as a so-called “pusher”.

Ejection devices for this purpose are, for example, shown and described in the “Automation” magazine of the Automation Publishing House, Penton Bldg., Cleveland, Ohio 44113/USA, September issue 1965, pages 102 to 112, and December issue 1965, pages 69 to 73. Furthermore, a permanent magnet 8 for biasing the material being conveyed is arranged in the start region of the conveyor belt 3, in order to improve the detection of interfering inclusions. In addition, two bags B lying on the conveyor belt 3, which consist of an aluminized foil and have to be checked for interfering inclusions, are shown by way of example. Such inclusions may originate from the production and bag filling machines and, for example, consist of VA steel which can be localized magnetically with difficulties only, said VA steel being particularly and mostly used in the food industry because of its properties.

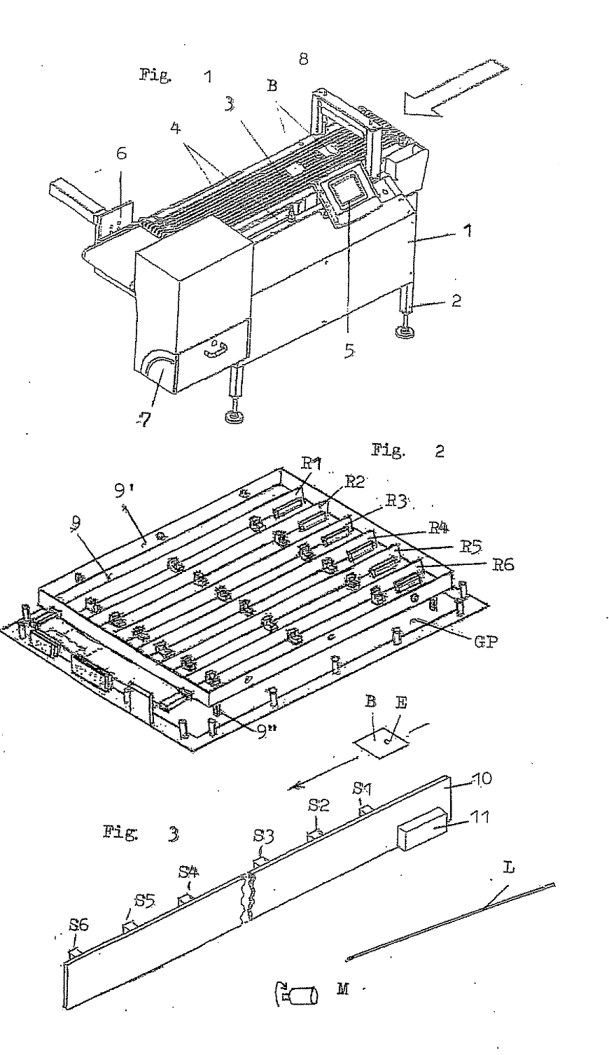

FIG. 2 shows the sensor matrix 4 in a separate view. Strip-like sensor rows R1 to R6 are arranged adjacent to each other on a circuit board 9 which is designed as a multilayer printed circuit, said strip-like sensor rows R1 to R6 being aligned such that the individual strips extend in the direction of transport of the conveyor belt 3 with the sensor matrix 4 being in the installed state. The circuit board 9 is held in a section frame 9′ in a torsionally stiff and rigid manner, said section frame 9′ being mounted on the base plate GP via spacers 9″, said base plate GP also supporting the connections for the further evaluation devices which are known as such. The individual sensor row consists of a strip-like support 10 which is also designed as a multilayer printed circuit which, in addition to the individual sensors, is also provided with the electronic components associated therewith, such as signal amplifiers, transistors, integrated circuits, capacitors, resistors, and an electric connector 11 for connection to an appropriate counterpart on the circuit board 9, etc. The electronic components mentioned are not shown in FIG. 2 for reasons of better clarity. The individual sensor strips are firmly anchored on the circuit board 9 via plastic brackets.

The strip R1 comprising its sensor row S1 to S6 is shown as an example in FIG. 3. The number of sensors in one row is primarily dependent on the required response sensitivity to inclusions to be discovered in the material being conveyed. Six sensors are provided in the exemplary embodiment. Eight sensors may also be arranged in practice. The individual sensors S1 to S6 are attached to the strip-like support 10 at uniform spacings such that they are oriented towards the conveyor belt 3 with the maximum of their spatial response characteristic—see FIG. 1. As seen spatially, the sensors mentioned mostly have an approximately clubbed characteristic rather than a ball characteristic. This characteristic can, for example, be measured by firmly mounting a sensor above a base plate spaced apart therefrom, displacing a sample body on the base plate, and measuring the sensor signal for the various positions of the sample body. This results in a three-dimensional diagram, as it is schematically depicted in FIG. 4 in the form of a Cartesian figure.

Above the support 10, FIG. 3 shows a bag B which is to be checked and contains an interfering inclusion E and successively passes the sensors S1 to S6 by means of the conveyor belt 3 shown in FIG. 1. Therein, the inclusion E triggers a signal in each of the sensors. Then, the individual sensor signals which are delayed with regard to each other are evaluated for the derivation of a detection signal in a correlated manner, as set out in the aforementioned DE 100 11 230. If a current-carrying conductor L, extends in the environment of the device, said conductor L is surrounded by a magnetic field which has a more or less strong effect on the sensors S1 to S6 and therefore causes corresponding sensor signals. A similar effect may occur if a machine with moving parts or a drive motor M is positioned in the vicinity of the sensors.

If the bag B comprising its interfering inclusion E is moved in the direction of the device indicated by an arrow in FIG. 3, the inclusion triggers signals in the individual sensors in a delayed manner, as shown in FIG. 5 in a diagram for sensors S1 to S6. The time is plotted along the abscissa while the amplitude of the individual sensor signals is plotted along the ordinate. The interfering signal which may actually have any amplitude curve is indicated by a rectangular signal. Its duration may be short or longer. If an interfering magnetic field acts upon the sensors, the interfering signal which has, for example, the form of a rectangle is superimposed on each individual sensor signal having an approximately bell-shaped amplitude curve. In its amplitude, this interfering signal can exceed the non-interfered sensor signal by a multiple, thus rendering an evaluation of the individual sensor signals impossible, most of said individual sensor signals being small in comparison therewith.

Surprisingly, such interfering signals practically have the same size and occur at the same time. If the output signal of another sensor is added to each sensor signal provided for evaluation in an antiphase manner, as has already been mentioned above, the interfering signal is suppressed almost completely and the individual sensor signals can be combined to form the desired detection signal by means of correlation without any difficulty. FIG. 6 shows this compensation in a diagram for the sensors S1 and S2, in the case where the interfering inclusion E passes the sensor 1. Both the sensor S1 and the sensor S2 are under the influence of the interfering external field practically to the same extent. An actual useful signal which is extremely small in comparison with the interfering signal is superimposed on the signal of the sensor S1, which is caused by the inclusion E. If the sensor signal of S2 is subtracted, this results in the actual useful signal for evaluation. If the bag B comprising the inclusion E is moved further in the direction of the arrow in FIG. 3, the inclusion E to be detected reaches the sensor S2 and, by subtracting the sensor signal either of S3 or S1, the sensor signal of S2 required for correlation evaluation can also be obtained from S2. It is also possible to use an adder instead of the subtracter Sub indicated in FIG. 6, if the polarity of one of the signals to be added is reversed prior to addition,

Actually, it would mostly be sufficient to derive the signal required for the compensation of interfering fields from one or a few sensors. According to a further development of the present invention, a particularly good compensation can be achieved by subtracting the signals of two sensors each from each other or by adding these signals in an antiphase manner, said sensors being arranged consecutively in the direction of transport of the material being conveyed and to be checked.

Such an embodiment is shown in FIG. 7 for an analog operating device. Two sensors each of the sensors S1 to S6, which are succeeding each other in the direction of transport, are connected to a subtracter Sub in analog technology. As is described in detail in German Patent Application No. DE 100 11 230, the outputs of these five subtracters are supplied to the adder Add via delay elements, such as delay lines or the like, said adder Add carrying out the correlation evaluation. It is also possible to receive a sixth signal—corresponding to the six sensors—by supplying the output signal of another sensor of the row, which is not immediately preceding, for example, the sensor S4, to a sixth subtracter which receives the signal of the sensor S6 as the second signal. This is indicated by the dashed line in FIG. 7. In this manner, all sensor signals can be utilized for the subsequent correlation and a further increase in the response sensitivity can be reached.

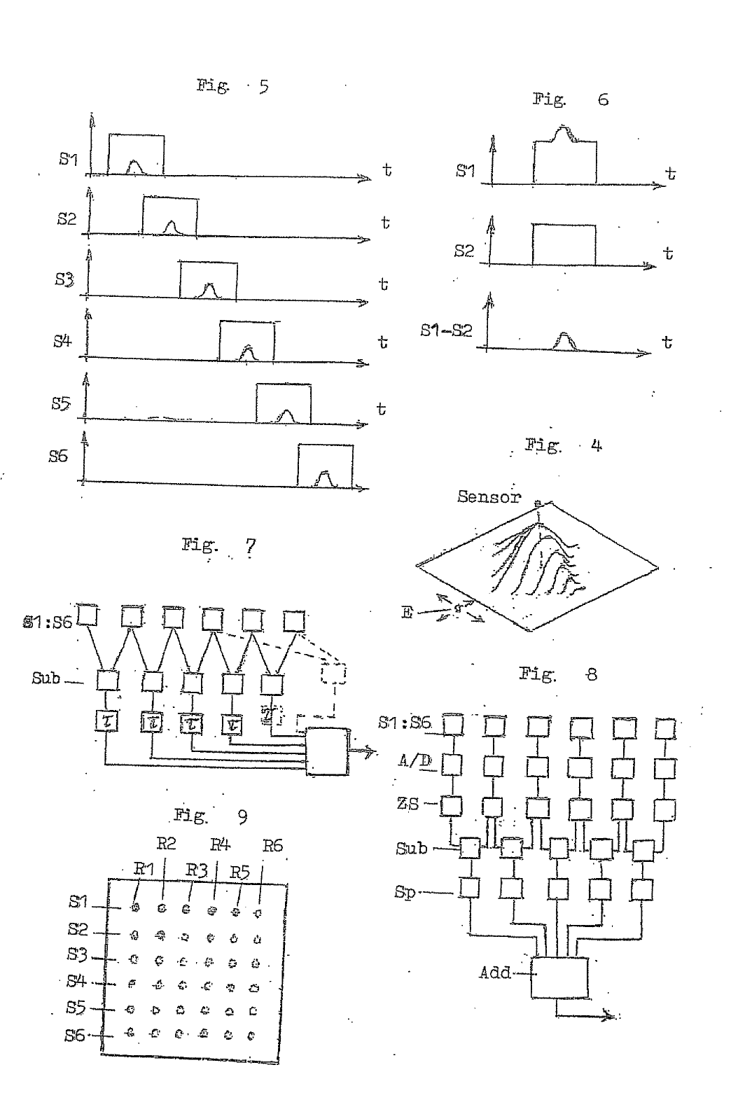

An example embodiment in digital technology is shown in FIG. 8. After having been preamplified, the output signals of the individual sensors S1 to S6 are subjected to a high-resolution analog-to-digital conversion in an analog-to-digital converter A/D. The latter scans the sensor signal which is initially still analog and transfers this signal into a sequence of scan samples which are then converted into a pulse-code-modulated signal PCM by means of a PCM converter PCM which mostly contains an intermediate storage ZS. Subsequently, the pulse-code-modulated signals are each supplied to a digitally operating subtracter Sub, the output signals of which are then filed to digitally operating storages Sp. Whenever a bag B has passed, the PCM signals filed in the storages are then read simultaneously, that means in a correlated manner, and supplied to the adder Add which generates the sum signal therefrom, said sum signal then serving as a basis for the detection signal.

FIG. 9 schematically shows a sensor matrix consisting of the sensor rows R1 to R6 and the sensors S1 to S6 provided for each row. Two sensors each can be used for the compensation of interfering fields with regard to their output signals in the manner described above. However, it must be ensured that the output signals of such sensors which do not originate from the same interfering inclusion at the same point in time are used for taking the difference. For example, the sensor 1 of the row R1 can be combined with the sensor 2 or sensor 3 of the row R2 for taking the difference. Usually, sensors which are immediately adjacent to each other and are arranged in neighboring rows are unsuitable whenever the sensors of neighboring rows are arranged relatively close to each other for reasons of a balanced characteristic—as illustrated in German Patent Application No. DE 100 11 230—because, in this case, the useful signal would also be weakened by taking the difference.

As has already been set out above, an additional shield against outside magnetic fields can also be applied in accordance with an example embodiment of the present invention, in order to enforce a homogenization of these fields. If, for this purpose, a tray made of a magnetic shielding material, for example of mumetal, which extends over the entire length of the sensor matrix 4 is arranged underneath the base plate GP, for example of a device according to FIGS. 1 and 2, the magnetic field lines of the interfering field will be aligned and therefore homogenized in the sensor range. In addition, such a tray can be provided above the base plate or only above the conveyor belt 3 in the area of the sensor matrix, thereby achieving a similar effect.

1-12. (canceled)

13. A device for monitoring a product stream for undesired inclusions, comprising:
a sensor system arranged in a section of the product stream to be monitored, the sensor system including a plurality of sensors arranged in a sensor row in a direction of transport of the product stream, at least one sensor of the sensor row provided for compensation of magnetic interfering fields; and
an evaluation circuit associated with the sensor system, the evaluation circuit simultaneously adding output signals of the sensors in an addition circuit in a correlated manner, the output signals originating from single products with regard to metal particles in the product stream to be monitored, wherein the output signal of the at least one sensor being added in an antiphase matter to the output signals of the other sensors for difference taking purpose, a resulting difference signal being correlated in the addition circuit, an output signal of the addition circuit being used as a detection signal for a metal particle to be discovered.

14. The device according to claim 13, wherein the output signals of two consecutive sensors each in the direction of transport are added in an antiphase manner for compensation of interfering outside magnetic fields and the signals resulting therefrom are correlated for forming the detection signal.

15. The device according to claim 14, wherein the output signals of two consecutive sensors each in the direction of transport are supplied to two inputs of a subtraction stage for the compensation of interfering outside magnetic fields, and the outputs thereof are connected to the addition circuit provided for correlation evaluation.

16. The device according to claim 13, wherein the difference signals are written to a storage device and are subsequently read out from the storage device for correlation evaluation.

17. The device according to claim 13, wherein the difference signals of one product pass each are correlated with each other in the form of analog signals for formation of the detection signal.

18. The device according to claim 13, further comprising:
a digital converter adapted to convert sensor signals into digital form prior to taking the difference signal, the converted signals being filed for each product pass to a storage device where they are supplied to the addition circuit provided for correlation evaluation after the product pass has been completed.

19. The device according to claim 13, wherein a plurality of sensor rows are arranged adjacent to each other and form a sensor matrix.

20. The device according to claim 19, wherein the output signals of sensors are provided for the compensation of interfering outside magnetic fields which pertain to different sensor rows and are offset against each other in the direction of transport.

21. The device according to claim 13, wherein spacing between sensors succeeding each other in the direction of transport is selected such that detection ranges of the sensors overlap each other in the direction of transport to an insignificant extent only.

22. The device according to claim 13, wherein the output of the sensor which is last in the direction of transport is connected to a further subtraction or addition stage to obtain a further difference signal, with another input of the subtraction or addition stage being connected to the output of a sensor which is offset by at least two sensor spacings.

23. The device according to claim 13, further comprising:
a magnetic shield provided against interfering outside magnetic fields, the magnetic shield containing an opening for the material being conveyed.

24. The device according to claim 23, wherein the magnetic shield is adapted to homogenize interfering magnetic fields.
